(19) United States
(12) Patent Application Publication
(10) Pub. No.: US 2016/0217170 A1
(43) Pub. Date: Jul. 28, 2016

(54) Method for Computing Optimal Consensus Rankings

(71) Applicant: Government of the United States, as represented by the Secretary of the Air Force, Wright-Patterson AFB, OH (US)

(72) Inventors: David C. Andescavage, Silver Spring, MD (US); Jeffrey F. Mates, Baltimore, MD (US)

(21) Appl. No.: 15/002,434

(22) Filed: Jan. 21, 2016

Related U.S. Application Data
(60) Provisional application No. 62/108,679, filed on Jan. 28, 2015.

(51) Int. Cl. G06F 17/30; G06N 3/12

(52) U.S. Cl. CPC G06F 17/30345; G06N 3/126

(57) ABSTRACT

A method, apparatus, and program product are provided for ranking a plurality of items. A plurality of items is received. Criteria associated with the plurality of items and weights associated with each criterion are defined. Intermediate rankings are either generated using at least one sorting algorithm or provided or both. A conformity matrix and scoring function are generated from the intermediate rankings. A customized genetic algorithm seeks a ranking that maximizes the scoring function by evolving a population of rankings according to each ranking's unsolved ranges. An unsolved range in a ranking is identified based on the conformity matrix and scoring function. In response to a ranking having additional unsolved ranges, the steps of identifying the unsolved range and rearranging the items using the customized genetic algorithm are repeated. In response a ranking have no additional unsolved ranges, the ranking for the plurality of items is provided.

### CROSS-REFERENCE TO RELATED APPLICATIONS

This application claims the benefit of and priority to U.S. Provisional Application Ser. No. 62/108,679, entitled “A Method for Computing Optimal Consensus Rankings,” filed on Jan. 28, 2015, the entirety of which is incorporated by reference herein.

### RIGHTS OF THE GOVERNMENT

The invention described herein may be manufactured and used by or for the Government of the United States for all governmental purposes without the payment of any royalty.

### BACKGROUND OF THE INVENTION

1. Field of the Invention

The present invention generally relates to prioritizing a given set of items and, more particularly, prioritizing based on a given set of criteria.

2. Description of the Related Art

Prioritizing, also known as ranking, is widely-used, for example, to produce “top ten” lists (of cars, movies, books, music, vacation spots, colleges, etc.), to make decisions from among a list of options, and to allocate scarce resources. Contemporary methods to prioritize items against a set of weighted criteria have limitations and disadvantages.

Some contemporary prioritization methods rely on heuristic methods. Heuristic methods are popular and widely-accepted for their simplicity, familiarity, and speed. Such methods may be reasonable when theoretical solutions are unknown, unavailable, or computationally intractable. However, ranking based on heuristic methods, e.g., point totals and expected values, may generally be unreliable and may produce inconsistent results. The reality is that modern computational processing speeds and mathematical algorithms have advanced sufficiently to allow individuals to replace heuristic ranking methods with the computational methods offered by ranking theory. These individuals would benefit from a prioritization method that utilizes mathematical sophistication, when optimal rankings are preferred and can be practically computed.

But, some contemporary prioritization methods are over-customized for a single application. This may be problematic for two primary reasons. Contemporary data sets pose significant dynamic challenges because the set of items, the weighted criteria, and even the ratings may change at a moment's notice. An overly-customized prioritization method may be too inflexible to adapt, if at all possible, as quickly. This realistic situation prompts individuals to redesign or modify their prioritization method whenever such changes occur, which may be an impractical burden for these individuals, especially for those individuals unfamiliar with the underlying theory. A prioritization method that does not keep pace with such changes may also yield inaccurate or misleading rankings.

Additionally, highly customized prioritization methods have limited, if any, applicability to other data sets. This high degree of customization means that a prioritization method used for ranking colleges may not readily apply to another data set ranking beachfront hotels, for example. This “a different method for a different problem” mentality ignores any commonalities shared by many prioritization problems. Rather than simplify the general task of prioritization, this mentality overwhelms individuals with a plurality of prioritization methods, each customized for a particular situation. These individuals would benefit from a robust prioritization method that seamlessly applies from one data set to another.

Other contemporary prioritization methods produce broad, “one ranking fits all users” conclusions. Such prioritization methods may produce misleading rankings because different individuals potentially have different criteria for ranking items. For example, consider a magazine that publishes a college ranking list based upon criteria such as “academic reputation,” “student selectivity,” “faculty resources,” and “alumni giving.” This magazine might then include in their published results “The best college of the year is . . . ” Parents, on the other hand, may actually desire a college ranking focused on a modified set of criteria, e.g., “faculty resources,” “graduation rate,” “student retention rate,” “financial aid,” and “average class size.” It is reasonable and expected that considering different criteria would yield different college rankings.

Accordingly, there is a need in the art for a single prioritization method that can be easily tailored to meet the unique differences among individuals.

### SUMMARY OF THE INVENTION

Embodiments of the invention address deficiencies in the art by providing mathematical ranking algorithms and a mathematical technique referred to as rank aggregation to compute an optimal consensus ranking. Up to practical computational constraints, such as time and memory, use of these embodiments may replace common ranking heuristics such as point totals and expected values. The method described with the embodiments of the invention naturally adapts to changes, e.g., weighted criteria and the set of items, without a need for a redesign. This is a consequence and an advantage of the ranking algorithms employed in the embodiments of the invention. For example, by changing the inputs individuals can perform “what-if” analysis without redesigning the method. Embodiments of the invention also allow individuals to customize prioritizations based upon user-relevant weighted criteria allowing the individuals to select relevant weighted criteria for their particular analysis. This element overcomes contemporary “one size fits all” rankings. Some of the embodiments of the invention may be configured to output the user-selected weighted criteria alongside the optimal consensus rankings. This increased transparency allows for the optimal consensus ranking to be interpreted within its proper context.

Embodiments of the invention provide a method, apparatus, and a program product for ranking a plurality of items. A plurality of items is received. Criteria associated with the plurality of items are defined. A weight associated with each criterion of the defined criteria is defined for each item of the plurality of items. In some embodiments, intermediate rankings are generated using at least one sorting algorithm. In other embodiments, the intermediate rankings may be provided. A conformity matrix and scoring function are generated from the intermediate rankings.

A customized genetic algorithm uses a population of individuals, the scoring function, and the conformity matrix to optimally rank the plurality of items. Each individual in the population includes a ranking of the plurality of items and metadata, i.e., a score, an age, and a list of unsolved ranges. An unsolved range in an individual contains subsets of this ranking that, if permuted, would increase the score. The age is a counter; it represents the number of generations for which it is a population member. The customized genetic algorithm seeks the individual or individuals, e.g., rankings of the plurality of items, with the largest possible score. Each generation of the customized genetic algorithm generally includes creation of new individuals from existing individuals, incrementing the age of existing individuals in the population.

In some embodiments, generating a child from an individual in the population of individuals includes selecting an unsolved range from the individual. An operation to mutate the selected unsolved range is randomly selected. The selected unsolved range is then mutated with the randomly selected operation. In response to additional unsolved ranges in the individual, a next unsolved range is selected from the individual. An operation to mutate the next unsolved range is randomly selected, and the next selected unsolved range is mutated with the randomly selected operation. In response to no additional unsolved ranges in the individual, the child is created representing a new ranking. In some embodiments, randomly selected operations include randomization, implosion, swapping, and combinations thereof.

In some embodiments, the customized genetic algorithm may terminate in response to a ranking that is discovered with no additional unsolved ranges or the customized genetic algorithm may terminate after a maximum number of iterations has been reached. In either case, the top scoring ranking, or rankings in case of a tie, are provided. In the former case, the optimal ranking has been determined. In the latter case, a nearly optimal ranking has been determined.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a block diagram outline the ranking methodology consistent with embodiments of the invention;

FIG. 2 is an exemplary list of items having unsolved ranges;

FIG. 3 is a flowchart illustrating a customized genetic algorithm consistent with embodiments of the invention;

FIG. 4 is a flowchart illustrating a procedure for creating an individual consistent with embodiments of the invention;

FIG. 5 is a flowchart illustrating a procedure for creating an offspring from an individual consistent with embodiments of the invention;

FIGS. 6A and 6B illustrate an unsolved range before and after a randomization mutation;

FIGS. 7A and 7B illustrate an unsolved range before and after an implosion mutation;

FIGS. 8A and 8B illustrate an unsolved range before and after a swap mutation; and

FIG. 9 is a schematic block diagram of an exemplary hardware and software environment suitable for implementing embodiments of the invention.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

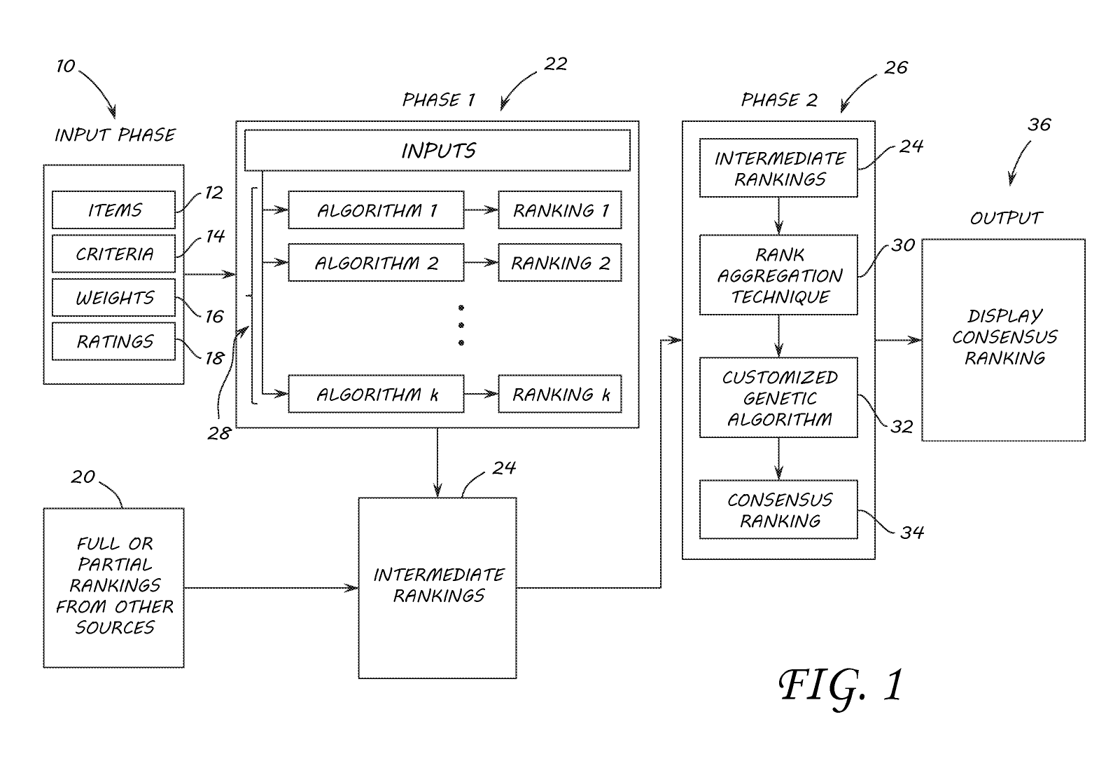

To address the need in the art, embodiments of the invention apply a method employing mathematical ranking algorithms and a rank aggregation technique to solve prioritization problems that fit the following general ranking model: rank a set [symbol] ={i₁, . . . , iₙ} of n items that have been scored, i.e., rated, against a set [symbol] ={c₁, . . . , cₘ} of m criteria and a multiset [symbol] ={w₁, . . . , wₘ} of corresponding criteria weights. These embodiments compute output from user input into two distinct and unique computational phases. FIG. 1 shows a general block diagram of an embodiment of the method.

At the Input Phase 10, the method accepts one or both of the following input types: (1) a list of items to rank 12, a list of criteria 14, weights for the criteria 16, and ratings 18 for each item 12 against each criterion 14 and (2) a list of full or partial rankings of the items 20. Beginning with the first type of input, this type of input may include the following elements: a set a [symbol] ={i₁, . . . , iₙ} of n items to be ranked 12, a set [symbol] ={c₁, . . . , cₘ} of m criteria 14 related to the items 12, a multiset [symbol] ={w₁, . . . , wₘ} of corresponding criteria weights 16, and the ratings for each item 12 against each criterion 14.

The set of items [symbol] represents the objects to be ranked 12. This general definition gives [symbol] maximum flexibility to represent anything an individual can enumerate. For example, the set [symbol] may represent teams in the NFL, a list of movies, houses for sale, etc. The set of criteria [symbol] 14 represents those factors that the individual will consider for prioritizing the items in [symbol] 12. The general definition of [symbol] allows individuals maximum flexibility to enumerate such factors. For example, the set [symbol] could represent a collection of houses for sale in a particular region. An individual may want to prioritize these houses to determine which meet their needs more than others. An individual's criteria for prioritizing these houses may include the following list: sales price, property taxes, miles to work, number of bedrooms, attached garage, finished basement, and number of bathrooms.

The criteria weights [symbol] 16 is a multiset of in non-negative integers. Any criterion 14 assigned a weight equal to 0 will be ignored by the method and be considered as irrelevant. Otherwise, the criterion 14 are considered to be relevant. For example, if the relevant criteria have equal weight, then the relevant criteria will be equally considered by later computations. This method makes no assumption about the origin and generation of the weights 16. The choice of weights 16 is problem-specific and it is outside the scope of the method. For example, consider the case of four criteria [symbol] ={c₁, c₂, c₃, c₄} and their corresponding weights w₁=1, w₂=1, w₃=2, and w₄=4, respectively. An individual may determine the relative weight of each criterion through a standard mathematical procedure such as normalization: divide each element of [symbol] by the sum of the elements of [symbol] . In this example, the sum of the elements of [symbol] equals 1+1+2+4=8 and the relative weights for the four criteria are ⅛(12.5%), ⅛ (12.5%), 2/8 (25%), and 4/8 (50%), respectively. In other embodiments or for other scenarios, other weighting methods may also be used.

Using the above four criteria set and establishing the set [symbol] 12 to represent a set of houses for sale, the set [symbol] 14 could represent the set of four criteria: commute to work, size of the yard, number of bedrooms, and sales price. If the criteria are assigned weights 1, 1, 2, and 4, respectively as above, then the output from this method will be a prioritization of the houses in [symbol] that considers the criterion “sales price” twice as heavily as “number of bedrooms” and four times as heavily as “yard size.” See Table 1 below. Generally, the criteria 14, weights 16, and ratings 18, for a set of items 12 may be expressed as a table [symbol] , such as that in Table 1, with m rows and n+2 columns. The rows may be indexed by the m criteria. The first (leftmost) column of [symbol] lists the criteria, the second column lists criteria weights, and then items index the remaining n columns of [symbol] . The order of the criteria and items is irrelevant for the formation of [symbol] . Each item is rated against each criterion. This method makes no assumption about the origin and generation of the ratings. There are many ways for individuals to assign such ratings. The details are problem-specific and the particulars are outside the scope of the method. However, ratings must be numeric or, if non-numeric, transformed into numeric values before continuing. In some embodiments, rating an item as zero against a particular criterion has a very specific interpretation, i.e., no rating is possible or known. The interpretation of non-zero ratings is problem-specific.

TABLE 1
Summary of Input

| | Weights | House 1 | House 2 | House 3 | House 4 | House 5 | House 6 | House 7 |
|---|---|---|---|---|---|---|---|---|
| Commute | 1.0 | | | | | | | |
| Yard Size | 1.0 | | | | | | | |
| Bedrooms | 2.0 | | | | | | | |
| Sales Price | 4.0 | | | | | | | |

The other type of input for the method is a set of full or partial rankings of the items 20. For embodiments of the invention, a full ranking of a set [symbol] ={i₁, . . . , iₙ} of n items is a permutation of these items. In particular, a set [symbol] with n items has n! possible full rankings. A partial ranking of a set [symbol] ={i₁, . . . , iₙ} is a full ranking of a non-empty proper subset of [symbol] . A set of full or partial rankings of this type may be considered when the specific rating data is unavailable or unknown. For example, an individual seeking to prioritize seven houses for sale in a region may ask a real estate agent for advice prioritizing them according to the four criteria. It is reasonable for the real estate agent to recommend a partial ranking of the houses to the user, e.g., House 2, House 4, House 3, House 7, House 6. In this example, the real estate agent does not have enough information to include House 1 or House 5 in the ranked list.

Next, Phase I 22 accepts the user input 10, 20 and creates a multiset [symbol] of intermediate rankings 24. In the case that the individual only inputs full or partial rankings, the multiset [symbol] equals these rankings. The method then continues to Phase II 26 immediately. In all other cases, the first step of Phase I 22 begins by transforming the table [symbol] , constructed above, into a matrix [symbol] for subsequent computations by the method. [symbol] is specifically formatted for computational compatibility with well-known and published ranking algorithms as well as other proprietary algorithms.

The matrix [symbol] has row [symbol] rows and col [symbol] columns where row [symbol] =w₁+ . . . +wₘ, the sum of the criteria weights, and col [symbol] =n, the number of items to rank. [symbol] is constructed from [symbol] as follows. For each row cᵢ of [symbol] , the next wᵢ rows of [symbol] are identical copies of row cᵢ. The order of the columns of [symbol] is the same as the order of the columns in [symbol] . For example, any irrelevant criterion does not appear in the matrix [symbol] . This is because irrelevant criteria have zero weight. If all relevant criteria have equal weights, then they appear in equal quantities in [symbol] . Embodiments of the invention apply a plurality of mathematical ranking algorithms denoted [symbol] ={ [symbol] ₁, . . . , [symbol] ₖ}. This non-empty set may include, but is not limited to, ranking algorithms due to Massey, Colley, Keener, and others. For example, the modularity of the method allows users to add, remove, and modify the set [symbol] . This may be especially useful for individuals that want to include the latest advances in ranking algorithms into embodiments of the invention or modify existing ranking algorithms in [symbol] . The software invention individually applies each ranking algorithm in [symbol] to the matrix [symbol] and produces one ranking of the items. Each ranking computed this way is called an intermediate ranking. Let [symbol] denote the multiset of intermediate rankings. If the input includes full or partial rankings 20, these are included in [symbol] 24 before proceeding to Phase II 26.

Phase II 26 applies a rank aggregation technique, Minimum Violations Ranking (MVR), to the multiset [symbol] of intermediate rankings 24. Solutions to a corresponding binary integer linear program (BILP) are rankings that maximize conformity, up to practical computational constraints such as time and memory, with the elements of [symbol] . While the mathematical details of the BILP are generally known by those of ordinary skill in the art, a minimal description is provided to facilitate the remaining detailed description of certain embodiments of the invention. We begin with the construction of a conformity matrix C and a scoring function ƒ. The conformity matrix summarizes how often each item is ranked above or below each other item with respect to the rankings in [symbol] . The (i,j) element of C is defined as

cᵢⱼ=(Number of rankings in [symbol] that rank i higher than j)−(Number of rankings in [symbol] that rank j higher than i) (1)

The conformity matrix, C, is skew symmetric meaning cᵢⱼ=−cⱼᵢ. The magnitude of each cᵢⱼ is bounded above by the number of intermediate rankings | [symbol] |. A larger positive value of cᵢⱼ means there is a stronger consensus among the rankings in [symbol] that item i should be ranked above item j. A smaller positive value of cᵢⱼ means there is a weaker consensus among the rankings in [symbol] for ranking item i above item j. A scoring function ƒ is a function from [symbol] ₙ, the set of permutations on {1, . . . , n}, to the integers defined as

$$f ( X ) = {\sum }_{i , j} {c}_{ij} {x}_{ij} \qquad ( 2 )$$

where the n² variables xᵢⱼ are indicators defined as xᵢⱼ=1 if the permutation X ranks item i above item j and xᵢⱼ=0 otherwise. The problem of finding the ranking, i.e., the permutation, which maximizes ƒ is known as the binary integer linear program (BILP).

The customized genetic algorithm (CGA) 32 described with the embodiments of the invention solves the BILP from a different perspective than contemporary “maximize the scoring function” approaches. Before describing the details of the CGA 32 used with embodiments of the invention, a few definitions are presented. A magnitude of a pair of items (i, j) is defined to be the value cᵢⱼ from the conformity matrix. A constraint is a pair of items (i, j) for which cᵢⱼ is positive. A pair of items with a zero magnitude will be referred to as a non-constraint. A ranking satisfies a constraint (i, j) if it ranks item i above item j; otherwise, the constraint (i, j) is unsatisfied. A scoring function ƒ is a sum of the magnitudes of satisfied and unsatisfied constraints for a given ranking. Any ranking that maximizes ƒ greedily satisfies as many constraints as possible while also maximizing the sum of the magnitudes. Thus, any ranking that satisfies every constraint must, by definition, maximize the scoring function.

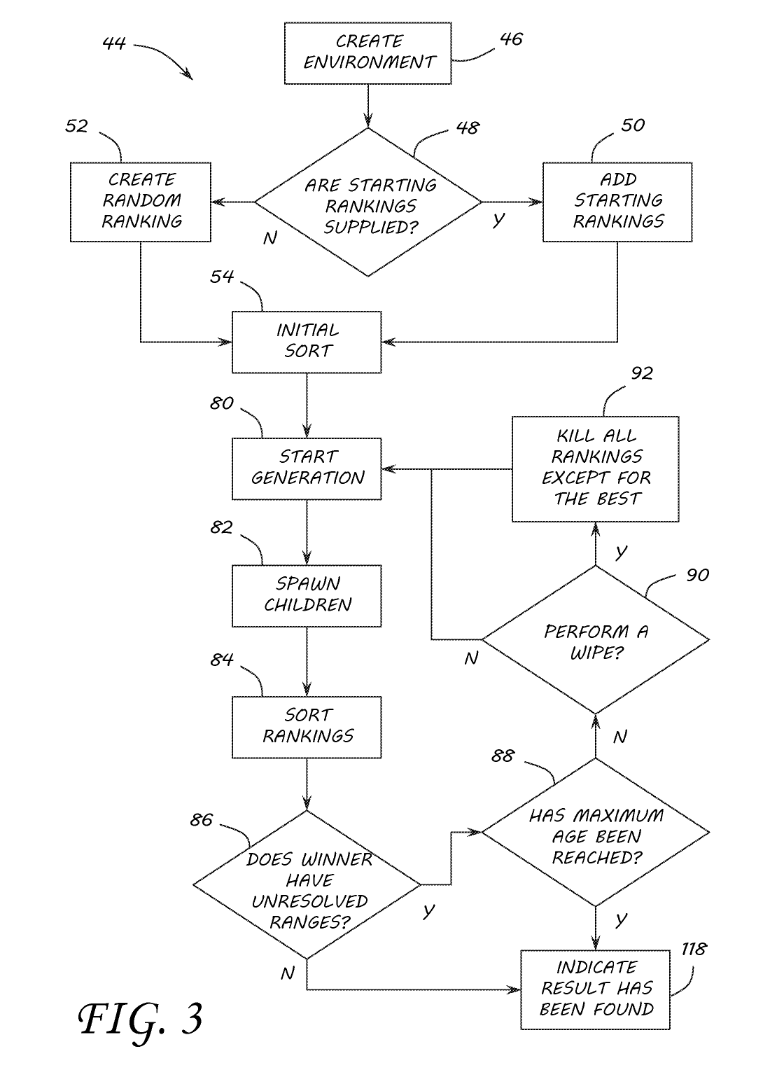

The CGA 32, as set out above, has several distinct components: the conformity matrix C, the scoring function ƒ, a list (population) of N individuals, an age threshold, and several mutation operators. FIG. 3 illustrates a block diagram of an embodiment of the CGA 32. Before proceeding with the CGA 32 description, it is necessary to introduce some preliminary concepts. The CGA 32 maintains a population P of size N individuals. Each individual represents a possible solution to the BILP. The CGA 32 defines individual as a list of four objects: a permutation σ of the set {1, . . . , n}, its score, its age, and its list of unsolved ranges. The permutation σ represents a ranking via the standard item-subscript identification. The individual's score equals the value ƒ(σ). The individual's age equals the number of generations the individual has been in the population. The unsolved ranges identify the location of unsatisfied constraints in σ.

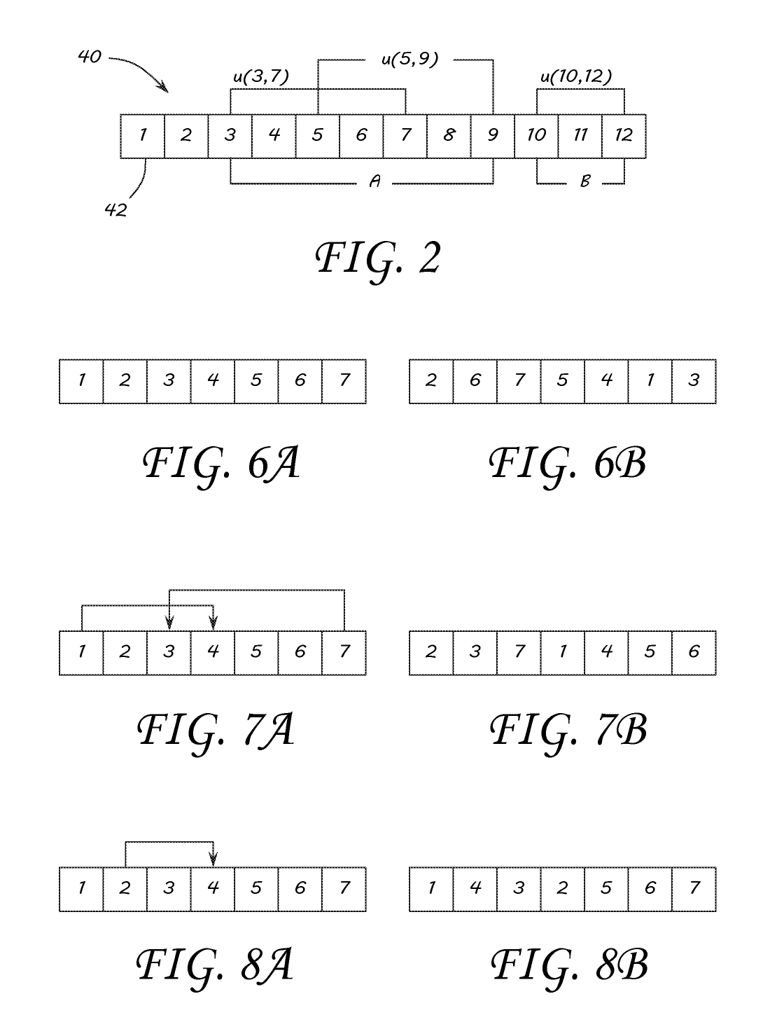

Each unsatisfied constraint (i, j) of a permutation σ identifies a pair of items that σ does not correctly rank, i.e., σ ranks item i higher than item j and cᵢⱼ<0. For a permutation σ and an unsatisfied constraint (i, j), the items ranked (inclusively) between items i and j, are called a simple unsolved range denoted u(i, j). More generally, a permutation σ may have a plurality of unsatisfied constraints and it is common for simple unsolved ranges to have non-empty intersections. An unsolved range u is the union of simple unsolved ranges u(i, j) where each u(i, j) has a non-empty intersection with at least one other simple unsolved range in the union. The length of an unsolved range is the number of items (inclusive) between its highest and lowest ranked items. FIG. 2 illustrates these concepts.

FIG. 2 shows an example ranking 40 of items 42 numbered 1 through 12. Suppose the conformity matrix is such that c_{3,7}, c_{5,9}, and c_{10,12} are negative. FIG. 2 depicts two unsolved ranges, denoted A and B. A is the union of two simple unsolved ranges u(3,7)=[3,4,5,6,7] and u(5,9)=[5,6,7,8,9]. The length of A is 7. B=u(10,12) is the other unsolved range and it has length 3. B is considered to be simple because it is not the union of multiple simple unsolved ranges.

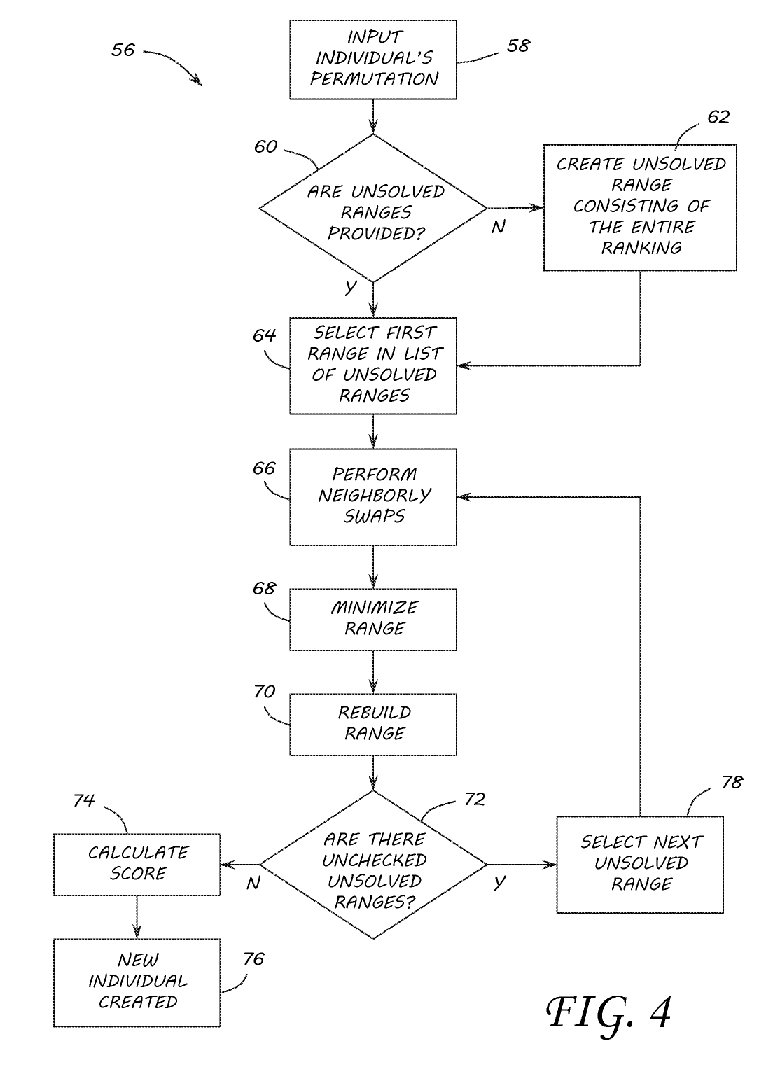

Turning now to flowchart 44 in FIG. 3, the CGA 32 begins by creating an environment by computing a conformity matrix, as set forth above. (Block 46). The CGA 32 then computes its initial population P of N individuals (Blocks 48-52). P is initially empty. Block 48 checks whether any full rankings were supplied during the Input Phase. Partial rankings are ignored in Block 48. If so, yes branch of Block 48, Block 50 appends any full rankings to the population P. If no full rankings were input, no branch of Block 48, Block 52 generates one individual at random and appends this to the population P. In this case, the corresponding permutation is selected randomly from [symbol] ₙ. Block 54 performs an initial sort, which fills the population with randomly generated individuals (see FIG. 4) until the population has size N, scores the individuals, and sorts them in descending order. In the case that two individuals have equal score, the individual with fewer unsatisfied constraints is sorted higher.

For computational reasons, individuals generated to initialize the population P are created from existing individuals in the population. FIG. 4 illustrates, via flowchart 56, how the current population members, defined in Block 50 or Block 52, are used to fill the initial population to size N. Turning now to FIG. 4, Block 58 accepts as input an individual from the population and only processes the permutation σ. Block 60 checks whether unsolved ranges exist in the individual from Block 58. If not, no branch of Block 60, Block 62 creates a single unsolved range equal to the permutation σ. A series of mathematical operations (Blocks 64, 66) sequentially examines the unsolved ranges of σ and reduces the lengths of the unsolved ranges. Block 64 selects the first unsolved range of σ. Block 66 identifies adjacent unsatisfied constraints within in the unsolved range and transposes them. This has the net effect of creating a permutation with a higher score and one less unsatisfied constraint. Removing these early saves computational cycles later in the CGA 32.

Block 68 identifies elements that are near the ends of unsolved ranges that can be transposed with an element outside the unsolved range without creating new unsolved constraints with elements of the unsolved range. Block 70 scans the unsolved range and determines whether it is the disjoint union of unsolved ranges. If so, the list of unsolved ranges is updated and the unsolved range is replaced with these disjoint unsolved ranges. This operation also reduces the amount of computations later in the CGA 32. Block 72 determines whether all unsolved ranges in u have been so reduced. If so, no branch of Block 72, Blocks 74, 76 compute the score of the resulting permutation and creates a new individual. This new individual is appended to the population. Otherwise, yes branch of Block 72, the next unsolved range is selected in Block 78 and processed, Blocks 66-70. Once the population is filled to size N the CGA 32 enters Block 80 in FIG. 3.

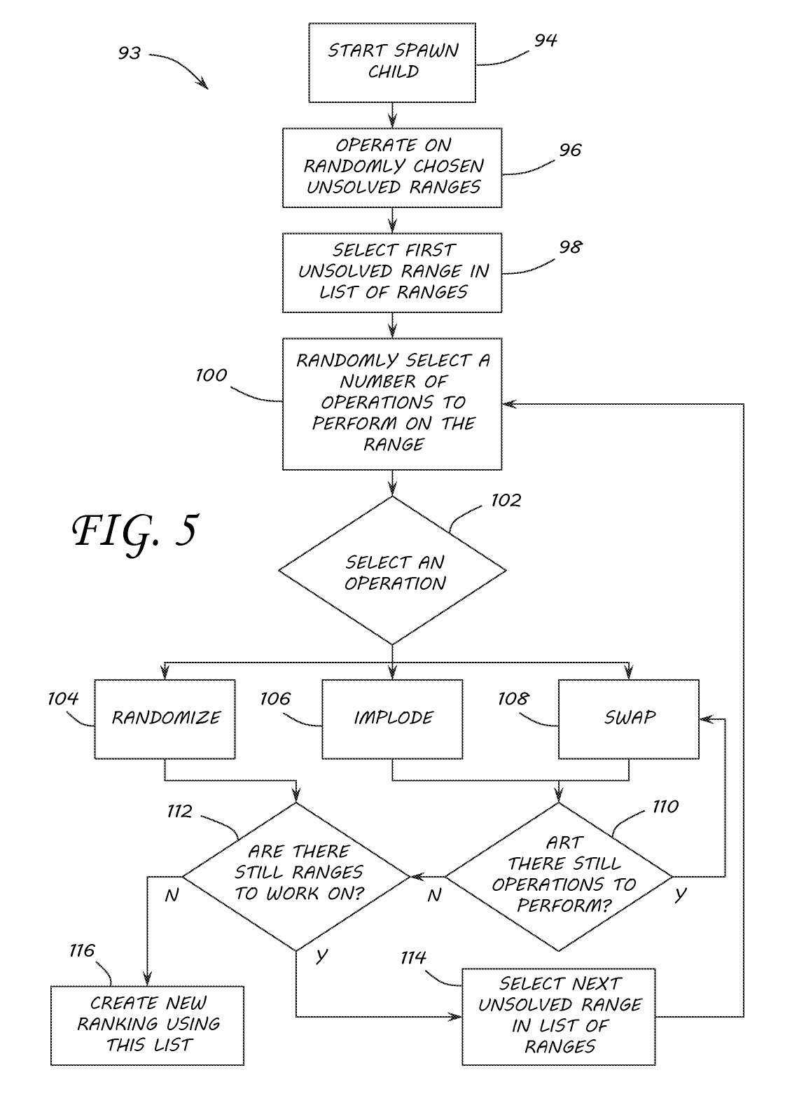

Returning now to FIG. 3, Blocks 80-92 represent a sequence of computations performed during a generation of the CGA 32. Block 80 signifies the beginning of the next generation. The age of each individual in the population increments by one. Block 82 creates children from the existing population individuals, referred to as parents. Each parent creates one offspring according to the procedure illustrated in FIG. 5.

Turning now to flowchart 93 in FIG. 5, Block 94 signifies the construction of one child from one parent. Block 96 selects a random number of unsolved ranges in the parent. The number of unsolved ranges so selected will be used as a counter. The unsolved ranges selected in Block 96 are processed sequentially by the operations in Blocks 100-114. Block 98 selects the first unsolved range from Block 96. For each unsolved range, Blocks 100-114 describe a sequence of three mathematical operators, known as mutators, which operate on the current unsolved range. In the illustrated embodiment, three mutators, randomize, swap, and implode, are illustrated in FIGS. 8-10. In some embodiments, one of two types of sequences is possible: (1) the randomize operator is applied once, or (2) a random sequence of swaps and implosions equal in length to the counter created in Block 96 is performed. Block 100 randomly selects a number of operations to perform on the current unsolved range. Block 102 then randomly selects one of the three mutation operators.

Block 104 applies a randomize operator to the unsolved range. This operator randomly permutes the elements of the unsolved range, as illustrated in the example in FIGS. 6A and 6B. FIG. 6A illustrates the unsolved range before randomization and FIG. 6B illustrates that unsolved range after randomization. If the randomize operator in Block 104 is applied, no further mutations are applied to this unsolved range. Block 106 applies an implosion operator to the unsolved range. The implosion operator's definition depends on a parity of the unsolved range's length. Without loss of generality, the implosion operator transforms an unsolved range of even length (1, 2, . . . , 2n) into (2, 3, . . . , n, 2n, 1, n+1, . . . , 2n−1) and an unsolved range of odd length (1, 2, . . . , 2n+1) into (2, 3, . . . , n, 2n+1, 1, n+1, . . . , 2n). An example for an odd length, n=3 unsolved range appears in FIGS. 7A and 7B. FIG. 7A illustrates the unsolved range before the implosion and FIG. 7B illustrates the resulting range after implosion. Block 108 applies a swap operator to the unsolved range. Swap randomly selects two items from the unsolved range and transposes them, as illustrated in FIGS. 8A and 8B. FIG. 8A illustrates the unsolved range before the swap operation and FIG. 8B illustrates the resulting range after the swap. Block 110 checks whether additional mutations are necessary based on the counter created in Block 96. In some embodiments, as with the illustrated embodiment, the additional mutations may only be swap operations. Though, other embodiments may employ other operations as part of the addition mutations. Block 112 checks whether additional unsolved ranges must be processed. If so, “Yes” branch of Block 112, the next unsolved range is selected for processing in Block 114. If not, “No” branch of Block 112, Block 116 creates a temporary individual with the permutation that results from Block 112.

The procedure in FIG. 4 described above processes the temporary individuals from Block 116 in FIG. 5 to compute and reduce the unsolved ranges in the temporary individual. The individual that results from the procedure in FIG. 4 is the new individual (created in Block 76). This new individual is scored and appended to the population.

Returning now to FIG. 3, as a result of Block 82, the population now has 2N individuals, the original N individuals from start of the current generation and the N newly created children. These 2N individuals are now sorted in descending order in Block 84. The CGA 32 examines the current top scoring individual, also known as the winner in Block 86. If the winner has an empty set of unsolved ranges, “No” branch of Block 86, then the CGA 32 concludes that this individual maximizes scoring function, i.e., the winner's permutation is a solution to the BILP. In this case, the CGA 32 terminates (Block 118) and in some embodiments displays output to a user, though the output in other embodiments may be any number of applications. Otherwise, “Yes” branch of Block 86, the CGA 32 proceeds to Block 88. Block 88 checks the age of the current winner. If the age exceeds a preset threshold, “Yes” branch of Block 88, the CGA 32 terminates at block 118. In this case, the CGA 32 has converged to a local maximum.

The result found in Block 118 is referred to as an optimal consensus ranking. The results indicate the optimal consensus ranking is a solution to the BILP (Block 86) or a local maximum (Block 88). Contemporary genetic algorithms may prematurely converge or they may converge to a local maximum. The CGA 32 utilized with embodiments of the invention attempts to mitigate this behavior tracking and checking an age of the top scoring individual (Block 88). If the age exceeds a preset threshold, “Yes” branch of Block 90, the CGA 32 preserves the top scoring individual and replaces the remaining N-1 individuals in Block 92 with randomly generated individuals in accordance with the procedure in FIG. 4. The population is then scored and sorted. If the age does not exceed the preset threshold, “No” branch of block 90, the CGA 32 begins a new generation at Block 80.

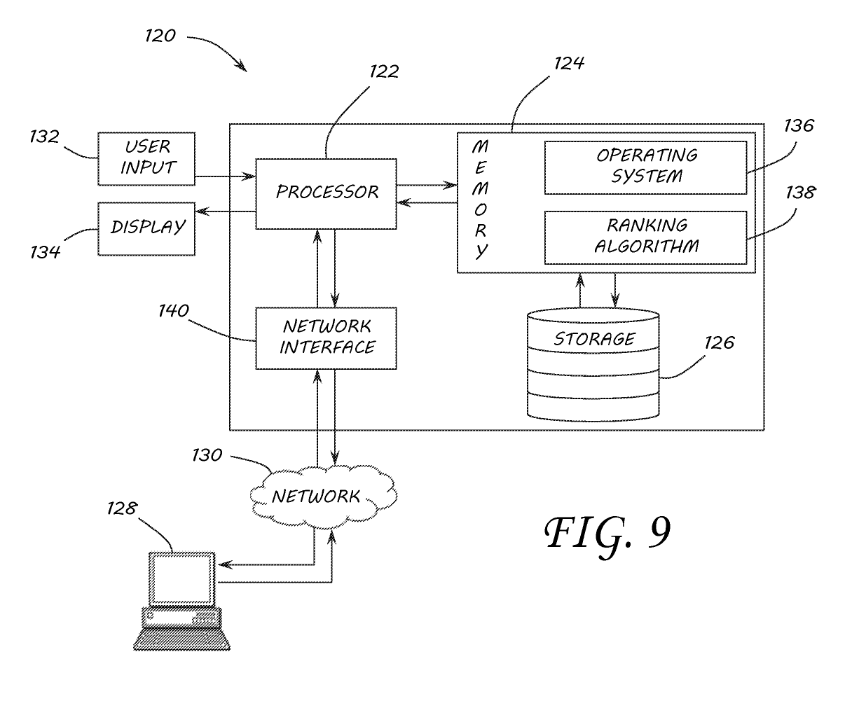

FIG. 9 illustrates an exemplary hardware and software environment for an apparatus 120 suitable for ranking items in a manner consistent with the invention. For the purposes of the invention, apparatus 120 may represent practically any computer, computer system, or programmable device, e.g., multi-user or single-user computers, desktop computers, portable computers, tablets, and devices, handheld devices, network devices, mobile phones, etc. Apparatus 10 will hereinafter be referred to as a “computer” although it should be appreciated that the term “apparatus” may also include other suitable programmable electronic devices.

Computer 120 typically includes at least one processor 122 coupled to a memory 124. Processor 122 may represent one or more processors (e.g. microprocessors), and memory 124 may represent random access memory (RAM) devices comprising the main storage of computer 120, as well as any supplemental levels of memory, e.g., cache memories, non-volatile or backup memories (e.g. programmable or flash memories), read-only memories, etc. In addition, memory 124 may be considered to include memory storage physically located elsewhere in computer 120, e.g., any cache memory in a processor 122, as well as any storage capacity used as a virtual memory, e.g., as stored on a mass storage device 126 or another computer 128 coupled to computer 120 via a network 130.

Computer 120 also typically receives a number of inputs and outputs for communicating information externally. For interface with a user or operator, computer 120 typically includes one or more user input devices 132 (e.g., a keyboard, a mouse, a trackball, a joystick, a touchpad, a keypad, a stylus, and/or a microphone, among others). Computer 120 may also include a display 134 (e.g., a CRT monitor, an LCD display panel or other projection device, and/or a speaker, among others). The interface to computer 120 may also be through an external device connected directly or remotely to computer 120, or through another computer communicating 128 with computer 120 via a network 130, modem, or other type of communications device.

Computer 120 operates under the control of an operating system 136, and executes or otherwise relies upon various computer software applications, components, programs, objects, modules, data structures, etc. (e.g. ranking algorithm 138). Computer 120 communicates on the network 130 through a network interface 140.

In general, the routines executed to implement the embodiments of the above described invention, whether implemented as part of an operating system or a specific application, component, program, object, module or sequence of instructions will be referred to herein as “computer program code”, or simply “program code”. The computer program code typically comprises one or more instructions that are resident at various times in various memory and storage devices in a computer, and that, when read and executed by one or more processors in a computer, causes that computer to perform the steps necessary to execute steps or elements embodying the various aspects of the invention. Moreover, while the invention has been described in the context of an application that could be implemented on fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include but are not limited to non-transitory physical, recordable type media such as volatile and non-volatile memory devices, floppy and other removable disks, hard disk drives, optical disks (e.g., CD-ROM's, DVD's, etc.), among others; and transmission type media such as digital and analog communication links.

In addition, various program code described may be identified based upon the application or software component within which it is implemented in specific embodiments of the invention. However, it should be appreciated that any particular program nomenclature is merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the invention is not limited to the specific organization and allocation of program functionality described herein.

Those skilled in the art will recognize that the exemplary environment illustrated in FIG. 9 is not intended to limit the present invention. Indeed, those skilled in the art will recognize that other alternative hardware and/or software environments may be used without departing from the scope of the invention.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A method for ranking a plurality of items, the method comprising:
receiving the plurality of items;
defining criteria associated with the plurality of items;
defining a weight associated with each criterion of the defined criteria for each item of the plurality of items;
generating an intermediate ranking using at least one sorting algorithm;
generating a conformity matrix and scoring function from the intermediate ranking;
identifying an unsolved range of items in the plurality of items based on the conformity matrix and scoring function;
resolving items in the unsolved range using a customized genetic algorithm;
in response to the plurality of items having additional unsolved ranges, repeating the steps of identifying the unsolved range and resolving the items using the customized genetic algorithm; and
in response to the plurality of items have no additional unsolved ranges, providing the ranking for the plurality of items.

2. The method of claim 1, further comprising:
in response to the plurality of items having additional unsolved ranges, terminating the ranking method after a maximum number of iterations has been reached; and
providing a best solution to the ranking for the plurality of items.

3. The method of claim 1, wherein the custom genetic algorithm comprises:
generating a population of individuals, wherein each individual includes a permutation of a ranking of the plurality of items, a score, an age, and a list of unsolved ranges;
incrementing an age of each individual in the population of individuals;
generating a child from each individual in the population of individuals, wherein each individual produces one child; and
sorting the population of individuals and generated children.

4. The method of claim 3, wherein generating a child from an individual in the population of individuals comprises:
selecting an unsolved range from the individual;
randomly selecting an operation to mutate the selected unsolved range;
mutating the selected unsolved range with the randomly selected operation;
in response to additional unsolved ranges in the individual, selecting a next unsolved range from the individual, randomly selecting an operation to mutate the next unsolved range, and mutating the next selected unsolved range with the randomly selected operation; and
in response to no additional unsolved ranges in the individual, creating the child representing a new ranking.

5. The method of claim 4, wherein the randomly selected operations are selected from a group consisting of randomization, implosion, swapping, and combinations thereof.

6. A method for ranking a plurality of items, the method comprising:
receiving the plurality of items;
defining criteria associated with the plurality of items;
defining a weight associated with each criterion of the defined criteria for each item of the plurality of items;
receiving an intermediate ranking;
generating a conformity matrix and scoring function from the intermediate ranking;
identifying an unsolved range of items in the plurality of items based on the conformity matrix and scoring function;
resolving items in the unsolved range using a customized genetic algorithm;
in response to the plurality of items having additional unsolved ranges, repeating the steps of identifying the unsolved range and resolving the items using the customized genetic algorithm; and
in response to the plurality of items have no additional unsolved ranges, providing the ranking for the plurality of items.

7. The method of claim 6, further comprising:
in response to the plurality of items having additional unsolved ranges, terminating the ranking after a maximum number of iterations has been reached; and
providing a best solution to the ranking for the plurality of items.

8. The method of claim 6, wherein the custom genetic algorithm comprises:
generating a population of individuals, wherein each individual includes a permutation of a ranking of the plurality of items, a score, an age, and a list of unsolved ranges;
incrementing an age of each individual in the population of individuals;
generating a child from each individual in the population of individuals, wherein each individual produces one child; and
sorting the population of individuals and generated children.

9. The method of claim 8, wherein generating a child from an individual in the population of individuals comprises:
selecting an unsolved range from the individual;
randomly selecting an operation to mutate the selected unsolved range;
mutating the selected unsolved range with the randomly selected operation;
in response to additional unsolved ranges in the individual, selecting a next unsolved range from the individual, randomly selecting an operation to mutate the next unsolved range, and mutating the next selected unsolved range with the randomly selected operation; and
in response to no additional unsolved ranges in the individual, creating the child representing a new ranking.

10. The method of claim 9, wherein the randomly selected operations are selected from a group consisting of randomization, implosion, swapping, and combinations thereof.

11. An apparatus comprising:
a memory;
a processor; and
program code resident in the memory and configured to be executed by the processor configured to rank a plurality of items, the program code further configured to receive the plurality of items, define criteria associated with the plurality of items, define a weight associated with each criterion of the defined criteria for each item of the plurality of items, generate an intermediate ranking using at least one sorting algorithm, generate a conformity matrix and scoring function from the intermediate ranking, identify an unsolved range of items in the plurality of items based on the conformity matrix and scoring function, resolve items in the unsolved range using a customized genetic algorithm, in response to the plurality of items having additional unsolved ranges, repeating the steps of identifying the unsolved range and resolve the items using the customized genetic algorithm, and in response to the plurality of items have no additional unsolved ranges, provide the ranking for the plurality of items.

12. The apparatus of claim 11, wherein the program code is further configured to:
in response to the plurality of items having additional unsolved ranges, terminate the ranking after a maximum number of iterations has been reached; and
provide a best solution to the ranking for the plurality of items.

13. The apparatus of claim 11, wherein the custom genetic algorithm of the program code is configured to:
generate a population of individuals, wherein each individual includes a permutation of a ranking of the plurality of items, a score, an age, and a list of unsolved ranges;
increment an age of each individual in the population of individuals;
generate a child from each individual in the population of individuals, wherein each individual produces one child; and
sort the population of individuals and generated children.

14. The apparatus of claim 13, wherein the program code is configured to generate a child from an individual in the population of individuals by:
selecting an unsolved range from the individual;
randomly selecting an operation to mutate the selected unsolved range;
mutating the selected unsolved range with the randomly selected operation;
in response to additional unsolved ranges in the individual, selecting a next unsolved range from the individual, randomly selecting an operation to mutate the next unsolved range, and mutating the next selected unsolved range with the randomly selected operation; and
in response to no additional unsolved ranges in the individual, creating the child representing a new ranking.

15. The apparatus of claim 14, wherein the randomly selected operations in the program code are selected from a group consisting of randomization, implosion, swapping, and combinations thereof.

16. A program product comprising:
a nontransitory computer recordable type medium; and
program code resident on the nontransitory computer recordable type medium and configured, when executed on a hardware implemented processor, to rank a plurality of items, the program code further configured to receive the plurality of items, define criteria associated with the plurality of items, define a weight associated with each criterion of the defined criteria for each item of the plurality of items, receive an intermediate ranking, generate a conformity matrix and scoring function from the intermediate ranking, identify an unsolved range of items in the plurality of items based on the conformity matrix and scoring function, resolve items in the unsolved range using a customized genetic algorithm, in response to the plurality of items having additional unsolved ranges, repeating the steps of identifying the unsolved range and resolve the items using the customized genetic algorithm, and in response to the plurality of items have no additional unsolved ranges, provide the ranking for the plurality of items.

17. The program product of claim 16, wherein the program code is further configured to:
in response to the plurality of items having additional unsolved ranges, terminate the ranking after a maximum number of iterations has been reached; and
provide a best solution to the ranking for the plurality of items.

18. The program product of claim 16, wherein the custom genetic algorithm of the program code is configured to:
generate a population of individuals, wherein each individual includes a permutation of a ranking of the plurality of items, a score, an age, and a list of unsolved ranges;
increment an age of each individual in the population of individuals;
generate a child from each individual in the population of individuals, wherein each individual produces one child; and
sort the population of individuals and generated children.

19. The program product of claim 18, wherein the program code is configured to generate a child from an individual in the population of individuals by:
selecting an unsolved range from the individual;
randomly selecting an operation to mutate the selected unsolved range;
mutating the selected unsolved range with the randomly selected operation;
in response to additional unsolved ranges in the individual, selecting a next unsolved range from the individual, randomly selecting an operation to mutate the next unsolved range, and mutating the next selected unsolved range with the randomly selected operation; and
in response to no additional unsolved ranges in the individual, creating the child representing a new ranking.

20. The program product of claim 19, wherein the randomly selected operations in the program code are selected from a group consisting of randomization, implosion, swapping, and combinations thereof.
